(19) United States
(12) Patent Application Publication
(10) Pub. No.: US 2020/0213144 A1
(43) Pub. Date: Jul. 2, 2020

(54) METHODS AND NETWORK NODES FOR PROVIDING COORDINATED FLOWCONTROL FOR A GROUP OF SOCKETS IN A NETWORK

(71) Applicant: Jon MALOY, Montreal (CA)

(72) Inventor: Jon MALOY, Montreal (CA)

(73) Assignee: TELEFONAKTIEBOLAGET LM ERICSSON (PUBL), Stockholm (SE)

(21) Appl. No.: 16/619,379

(22) PCT Filed: Jun. 8, 2017
(86) PCT No.: PCT/IB2017/053394

§ 371 Date: Dec. 4, 2019

(51) Int. Cl. H04L 12/18; H04L 12/761; H04L 12/807; H04L 12/805; H04L 29/06

(52) U.S. Cl. CPC H04L 12/185; H04L 45/16; H04L 65/4076; H04L 47/365; H04L 47/27

(57) ABSTRACT

A group of sockets perform coordinated flow control in a communication network. A receiver socket in the group advertises a minimum window as a message size limit to a sender socket when the sender socket joins the group. Upon receiving a message from the sender socket, the receiver socket advertises a maximum window to the sender socket to increase the message size limit. The minimum window is a fraction of the maximum window.

### TECHNICAL FIELD

Embodiments of the disclosure relate generally to systems and methods for network communication.

### BACKGROUND

The Transparent Inter-Process Communication (TIPC) protocol allows applications in a clustered computer environment to communicate quickly and reliably with other applications, regardless of their location within the cluster. A TIPC network consists of individual processing elements or nodes. TIPC applications typically communicate with one another by exchanging data units, known as messages, between communication endpoints, known as ports. From an application's perspective, a message is a byte string from 1 to 66000 bytes long, whose internal structure is determined by the application. A port is an entity that can send and receive messages in either a connection-oriented manner or a connectionless manner.

Connection-oriented messaging allows a port to establish a connection to a peer port elsewhere in the network, and then exchange messages with that peer. A connection can be established using a handshake mechanism; once a connection is established, it remains active until it is terminated by one of the ports, or until the communication path between the ports is severed. Connectionless messaging (a.k.a. datagram) allows a port to exchange messages with one or more ports elsewhere in the network. A given message can be sent to a single port (unicast) or to a collection of ports (multicast or broadcast), depending on the destination address specified when the message is sent.

In a group communication environment, a port may receive messages from one or more senders, and may send messages to one or more receivers. In some scenarios, messages sent by connectionless communication may be dropped due to queue overflow at the destination; e.g., when multiple senders send messages to the same receiver at the same time. Simply increasing the receive queue size to prevent overflow can risk memory exhaustion at the receiver, and such an approach would not scale if the group size increases above a limit. Moreover, some messages may be received out of order due to lack of effective sequence control between different message types. Therefore, a solution is needed that is theoretically safe for group communication, yet does not severely restrain throughput under normal circumstances.

### SUMMARY

In one embodiment, a method is provide for a receiver socket in a group of sockets in a network to provide flow control for the group. The method comprises: advertising a minimum window as a message size limit to a sender socket when the sender socket joins the group; receiving a message from the sender socket; and upon receiving the message, advertising a maximum window to the sender socket to increase the message size limit, wherein the minimum window is a fraction of the maximum window.

In one embodiment, a method is provide for a sender socket in a group of sockets in a network to provide sequence control for the group. The method comprises: sending a first message from the sender socket to a peer member socket by unicast; detecting that a second message from the sender socket, which immediately follows the first message, is to be sent by broadcast; and sending the second message by replicated unicasts, in which the second message is replicated for all destination nodes and each replicated second message is sent by unicast.

In one embodiment, a node containing a receiver socket in a group of sockets is provided in a network. The node is adapted to perform flow control for communicating with the sockets in the group. The node comprises a circuitry adapted to cause the receiver socket in the node to perform the following: advertise a minimum window as a message size limit to a sender socket when the sender socket joins the group; receive a message from the sender socket; and upon receiving the message, advertise a maximum window to the sender socket to increase the message size limit, wherein the minimum window is a fraction of the maximum window.

In one embodiment, a node containing a sender socket in a group of sockets is provided in a network. The node is adapted to perform sequence control for communicating with the sockets in the group. The node comprises a circuitry adapted to cause the sender socket in the node to perform the following: send a first message to a peer member socket by unicast; detect that a second message from the sender socket, which immediately follows the first message, is to be sent by broadcast; and send the second message by replicated unicasts, in which the second message is replicated for all destination nodes and each replicated second message is sent by unicast.

In one embodiment, a node containing a receiver socket in a group of sockets is provided in a network. The node is adapted to perform flow control for communicating with the sockets in the group. The node comprises a flow control module adapted to advertise a minimum window as a message size limit to a sender socket when the sender socket joins the group; and an input/output module adapted to receive a message from the sender socket. The advertisement module is further adapted to advertise, upon receiving the message, a maximum window to the sender socket to increase the message size limit, wherein the minimum window is a fraction of the maximum window.

In one embodiment, a node containing a sender socket in a group of sockets is provided in a network. The node is adapted to perform sequence control for communicating with the sockets in the group. The node comprises an input/output module adapted to send a first message from the sender socket to a peer member socket by unicast; and a sequence control module adapted to detect that a second message is to be sent by broadcast, which is immediately preceded by a first message sent from the sender socket by unicast. The input/output module is further adapted to send the second message by replicated unicasts, in which the second message is replicated for all destination nodes and each replicated second message is sent by unicast.

In one embodiment, a method is provided for a receiver socket in a group of sockets in a network to provide flow control for the group. The method comprises initiating an instantiation of a node instance in a cloud computing environment which provides processing circuitry and memory for running the node instance. The node instance is operative to: advertise a minimum window as a message size limit to a sender socket when the sender socket joins the group; receive a message from the sender socket; and upon receiving the message, advertising a maximum window to the sender socket to increase the message size limit, wherein the minimum window is a fraction of the maximum window.

In one embodiment, a method is provided for a sender socket in a group of sockets in a network to provide sequence control for the group. The method comprises initiating an instantiation of a node instance in a cloud computing environment which provides processing circuitry and memory for running the node instance. The node instance is operative to: send a first message from the sender socket to a peer member socket by unicast; detect that a second message from the sender socket, which immediately follows the first message, is to be sent by broadcast; and send the second message by replicated unicasts, in which the second message is replicated for all destination nodes and each replicated second message is sent by unicast.

Other aspects and features will become apparent to those ordinarily skilled in the art upon review of the following description of specific embodiments in conjunction with the accompanying figures.

### BRIEF DESCRIPTION OF THE DRAWINGS

Embodiments will now be described, by way of example only, with reference to the attached figures.

FIG. 1 illustrates an example of a socket joining a group of sockets according to one embodiment.

FIGS. 2A, 2B, 2C and 2D illustrate different communication patterns between a sender socket and its peer member sockets according to one embodiment.

FIG. 3 illustrates a finite state machine maintained by a receiver socket according to one embodiment.

FIG. 4 illustrates a multipoint-to-point flow control diagram according to one embodiment.

FIG. 5 illustrates a multipoint-to-point flow control diagram according to another embodiment.

FIG. 6 illustrates a point-to-multipoint flow control diagram for unicast according to one embodiment.

FIG. 7 illustrates a point-to-multipoint flow control diagram for multicast according to one embodiment.

FIGS. 8A and 8B illustrate two alternatives for sending a group broadcast according to some embodiments.

FIG. 9 illustrates a sequence control mechanism for a sender socket sending a broadcast immediately after a unicast according to one embodiment.

FIG. 10 illustrates another sequence control mechanism for a sender socket sending a unicast immediately after a broadcast according to one embodiment.

FIG. 11 is a flow diagram illustrating a flow control method according to one embodiment.

FIG. 12 is a flow diagram illustrating a sequence control method according to one embodiment.

FIG. 13 is a block diagram of a network node according to one embodiment.

FIG. 14A is a block diagram of a network node performing flow control according to one embodiment.

FIG. 14B is a block diagram of a network node performing sequence control according to one embodiment.

FIG. 15 is an architectural overview of a cloud computing environment according to one embodiment.

### DETAILED DESCRIPTION

Reference may be made below to specific elements, numbered in accordance with the attached figures. The discussion below should be taken to be exemplary in nature, and should not be considered as limited by the implementation details described below, which as one skilled in the art will appreciate, can be modified by replacing elements with equivalent functional elements.

Systems, apparatuses and methods are provided herein for loss-free communication among a group of sockets. The term “loss-free” herein means that all sent messages arrive to the destination in exactly one copy (i.e., cardinality guarantee) and in the order they were sent out (i.e., sequentiality guarantee). The communication mechanisms to be described herein provide an improvement in comparison to the conventional communication protocols such as TIPC and Transmission Control Protocol (TCP) by enabling efficient and robust flow control and sequence control in a group communication.

The communication mechanisms to be described herein are memory and resource efficient. In one embodiment, each socket initially reserves a minimum window (Xmin) in its receive queue for each peer member in the group. The window increases to a maximum window (Xmax) for a peer member when that peer member becomes active; i.e., when that peer member starts sending messages to the socket. In one embodiment, Xmin may be set to the maximum size of a single message limited by the underlying communication protocol (e.g., 66 Kbytes in TIPC), and Xmax may be a multiple of Xmin where Xmax>>Xmin; e.g., Xmax may be set to ten times of Xmin. By contrast, according to the conventional TIPC and TCP, a socket reserves only 1×Xmax, for each socket has only one peer at the other end of the connection; however, each member is forced to create N sockets, one per peer. Thus, with conventional TIPC and TCP, each member needs to reserve N×Xmax for communicating with N peers.

According to the flow control provided herein, one single member socket reserves windows for all its peers, where the size of each window is determined based on demand and availability; hence the socket can coordinate its advertisements to the peers to limit the reserved space. As the number of active peer members at any moment in time is typically much smaller than the total number of peer members, the average receive queue size in each socket can be significantly reduced. The management of advertised windows is part of a flow control mechanism for preventing the reduced-sized receive queue from overflow, even if multiple peer members transmit messages to the receive queue at the same time.

Moreover, a sequence control mechanism is provided to ensure the sequential delivery of messages transmitted in a group when the messages are sent in a sequence of different message types; e.g., a combination of unicasts and broadcasts. The conventional TIPC contains an extension to the link layer protocols that guarantees that broadcast messages are not lost or received out of order, and that unicast messages are not lost or received out of order. However, there is no guarantee that a sequence of a broadcast message and a unicast message can be transmitted in the mutual sequential order. Thus, at the link layer, a broadcast message that is sent subsequent to a unicast message may bypass that unicast message to arrive at the destination before the unicast message; similarly, a unicast message that is sent subsequent to a broadcast message may bypass that broadcast message and arrive at the destination before the broadcast message. As will be described herein, the sequence control guarantees the sequential delivery of broadcast messages and unicast messages.

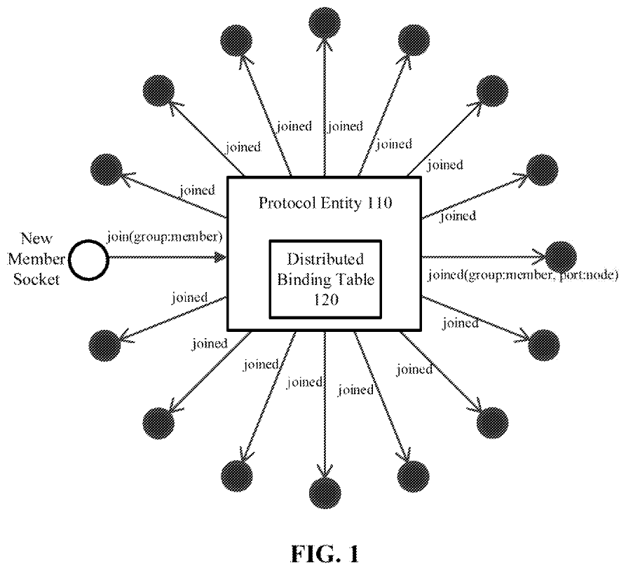

FIG. 1 illustrates a group of sockets in a communication network according to one embodiment. A “socket,” as used herein, is a communication entity residing on a node (e.g., a physical host). A group of sockets may reside on one or more nodes, where in the case of multiple nodes, the multiple nodes may have different processor types or use different operating systems. One or more sockets may reside on the same node. Each socket is uniquely identified by a socket identifier; e.g., in the form of (Node, Port), where Node identifies the node on which the socket is located, and Port identifies the communication endpoint on the node for sending and receiving messages. Multiple sockets can form a group; each socket in the group is referred to as a group member, a member socket, or a member. A socket may exchange messages only with its peer members, that is, the other sockets of the same group.

Sockets communicate with one another according to a communication protocol. In this example, the sockets transmit and receive messages through a protocol entity 110, which performs protocol operations and coordinates with other communication layers such as the link layer. The protocol entity 110 maintains a distributed binding table 120 for registering group membership. In one embodiment, the distributed binding table 120 is distributed or replicated on all of the nodes containing the sockets. The distributed binding table 120 records the association or mapping between each member identity (ID) in the group and the corresponding socket identifier. Each member socket is mapped to only one member ID; the same member ID may be mapped to more than one socket.

The group membership is updated every time a new member joins the group or an existing member leaves the group. A socket may join a group by sending a join request to the protocol entity 110. The join request identifies the group ID that the socket requests to join and the member ID to which the socket requests to be mapped. A socket may request to leave a group by sending a leave request to the protocol entity 110. The leave request identifies the group ID that the socket requests to leave and the member ID with which the socket requests to be disassociated. Each member socket may subscribe to membership updates. The subscribing member sockets receive updates from the protocol entity 110 when a new member joins a group and when an existing member leaves the group. Each membership update identifies the association or disassociation between a member ID and a (Node, Port) pair, as well as the group ID.

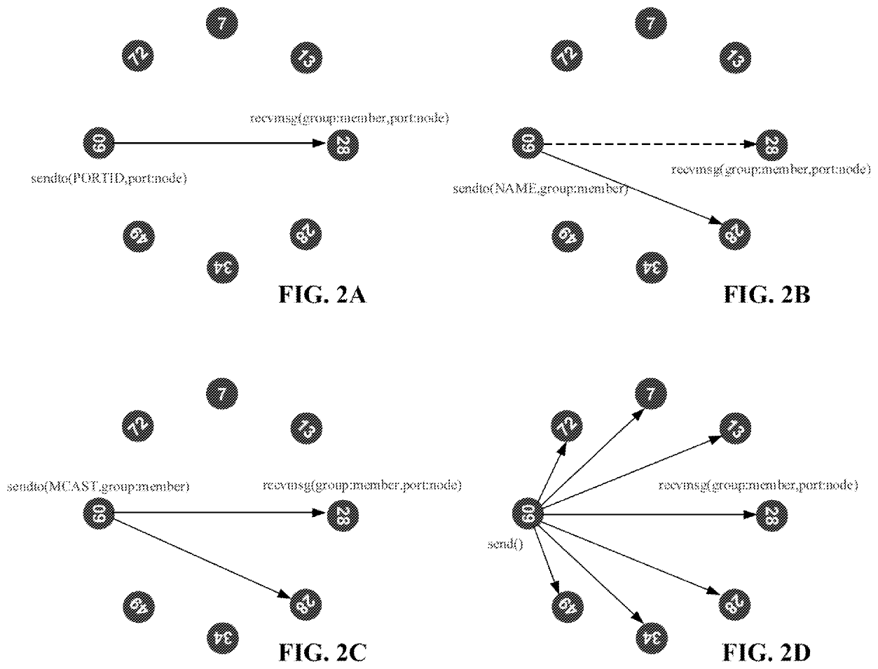

FIGS. 2A-2D illustrate some of the message types that may be used by a socket for communicating with its peer members. In one embodiment, the message types include unicast, anycast, multicast and broadcast. Each circle in FIGS. 2A-2D represents a socket, and the number on a socket represents the member ID of that socket. FIG. 2A illustrates an example of unicast, by which a sender socket sends a message to a recipient identified by a socket identifier that uniquely identifies a receiver socket. FIG. 2B illustrates an example of anycast, by which a sender socket sends a message to a recipient identified by a member ID. Since a member ID may be mapped to more than one socket, the anycast message can be sent to any one of the sockets associated with the member ID. In some embodiments, the anycast message from a sender socket may be sent to one of the multiple sockets associated with the same member ID. The recipient socket may be selected from such multiple sockets by round-robin, by load level (e.g., the available capacity or the number of active peer members), a combination of round-robin and load level, or based on other factors. The selection of the recipient socket may be performed by the protocol entity 110 of FIG. 1, the sender socket, or by both in collaboration. In the example of FIG. 2B, the solid line and the dashed line indicate the two alternative paths for transmitting an anycast message from a sender socket to one of the two sockets having member ID=28. In an embodiment where the selection criterion is a combined round-robin and load level, the lower socket 28 may be selected first by round-robin as the recipient of an anycast message. But if the lower socket 28 has not advertised enough window for sending the anycast message at the moment, the next socket with the same member ID (e.g., the upper socket 28) is selected and checked for its advertised window size. In a scenario where there are more than two sockets with the same member ID, the process continues until a socket with the same member ID is found that meets the selection criterion. In one embodiment, if no destination socket with sufficient window is found, the first socket according to the round-robin algorithm may be selected, and the sender socket is held back from sending until the selected socket advertises more window.

FIG. 2C illustrates an example of multicast, by which a sender socket sends a message to multiple recipients identified by one or more member IDs. All of the sockets associated with the one or more member IDs receive a copy of the message. In the example of FIG. 2C, both sockets with member ID=28 receive the multicast message. If multiple sockets are associated with the same member ID identified as multicast recipients, all of these sockets receive a copy of the message.

FIG. 2D illustrates an example of broadcast, by which a sender socket sends a message to all of the peer members. In one embodiment, a broadcast message may be transmitted from a sender socket to the protocol entity 110 (FIG. 1), which replicates the message and transmits the message copies via a link layer switch to all of the peer members.

At any given time, any given socket may act as a sender socket that sends messages to multiple peer members, such as in the case of multicast and broadcast. Any given socket may also act as a receiver socket that is the common destination for messages from multiple peer members. The former scenario is referred to as a point-to-multipoint scenario and the latter scenario is referred to as a multipoint-to-point scenario. The following description explains a multipoint-to-to flow control mechanism which protects the receiver socket's receive queue from overflow. The multipoint-to-point flow control mechanism ensures that the combined message sizes from multiple peer members stays with the available capacity of the receive queue.

A high-level description of embodiments of the flow control mechanism is as follows. When a receiver socket receives a membership update indicating that another socket (peer member) joins its group, the receiver socket sends a first advertisement providing a minimum window to the peer member. In one embodiment, the minimum window is the maximum size of a message that the peer member can send to the receiver socket, for example. In one embodiment, the advertisement is carried in a dedicated, very small protocol message. Advertisements are handled directly upon reception, and are not added to the receive queue. After the receiver socket receives a message from the peer member, the receiver socket sends a second advertisement providing a maximum window to the peer member. The maximum window allows the peer member to send multiple messages to the receiver socket. When the maximum window is at or near a predetermined threshold, the receiver socket can replenish the window to allow the peer member to continue sending messages to the receiver socket. As such, the receiver socket can reserve space in its receive queue based on the demand of the peer members. Only those peer members that are actively sending messages are allocated a maximum window; the others are allocated a minimum window to optimize the capacity allocation in the receive queue.

In one embodiment, each member socket keeps tracks of, per peer member, a send window for sending messages to that peer member and an advertised window for receiving message from that peer member. The send window is consumed when the member socket sends messages to the peer member, and is updated when the member socket receives advertisements from the peer member. The advertised window is consumed when the member socket receives messages from the peer member, and is updated when the member socket sends advertisements to the peer member. A sender socket waits for advertisement if its send window for the message's recipient is too small. In a point-to-multipoint scenario, a sender socket waits for advertisement if its send window for any of the message's recipients is too small.

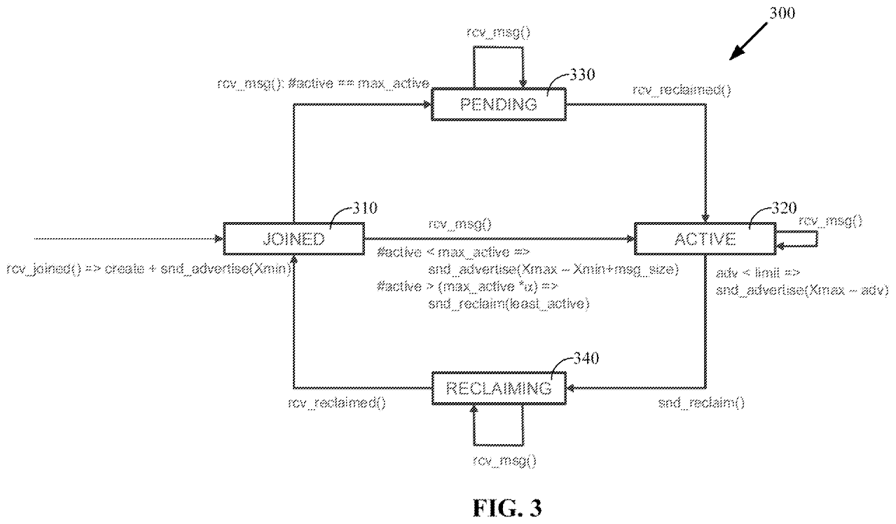

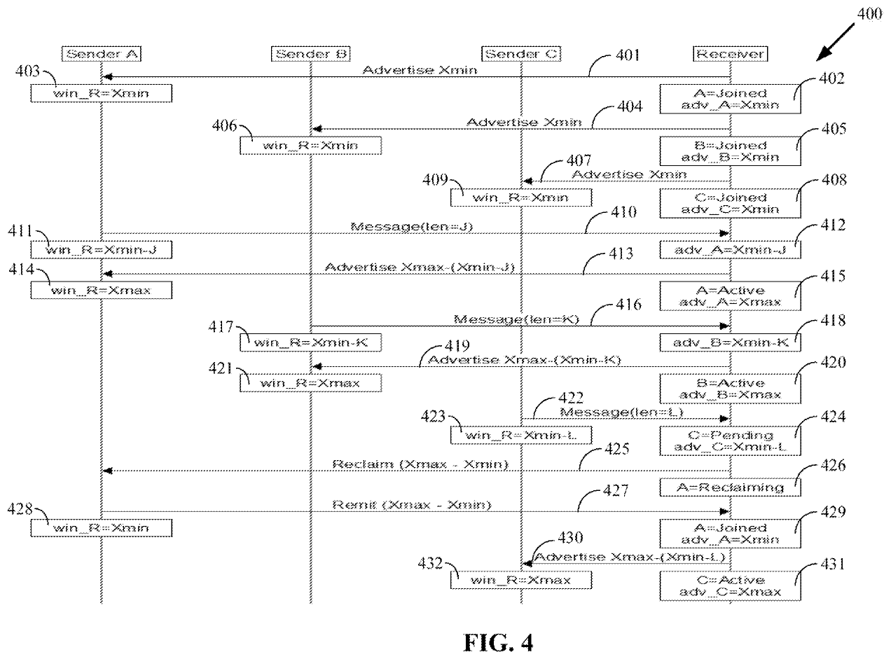

FIG. 3 is a diagram illustrating a finite state machine (FSM) 300 maintained by each socket according to one embodiment. The FSM 300 is used by a receiver socket to track the sending states of its peer members. The FSM 300 includes four sending states: a JOINED state 310, an ACTIVE state 320, a PENDING state 330 and a RECLAIMING state 340. The sending states and the transitions among them will be explained below with reference to FIG. 4.

FIG. 4 illustrates a multipoint-to-point flow control diagram 400 according to one embodiment. The diagram 400 illustrates message exchanges between a receiver socket (Receiver) and three peer members (Sender A, Sender B and Sender C). Initially, Receiver receives membership updates from the protocol entity 110 (FIG. 1) informing that Sender A has joined the group. At step 401, Receiver advertises a minimum window, Xmin, to Sender A. After sending the advertisement, Receiver places Sender A in the JOINED state 310 and records the advertised window for Sender A as Adv_A=Xmin at step 402. Sender A records its send window for Receiver as win_R=Xmin at step 403. Steps 404-406 for Sender B and steps 407-409 for Sender C are similar to steps 401-403 for Sender A.

At step 410, Sender A sends a message of size J to Receiver, and reduces win_R, its send window for Receiver, to (Xmin−J) at step 411. Upon receiving the message, Receiver reduces Adv_A, which is the advertised window for Sender A, to (Xmin−J) at step 412. Receiver at this point determines whether its receive queue is nearly full. In one embodiment, the determination may be made by the number of active senders (# active) that Receiver currently has in the group. If the number of active senders for Receiver is less than a threshold (i.e., # active<max_active), Receiver may increase the window for Sender A to the maximum window Xmax. In this example, max_active=2. Thus, Receiver at step 413 may send a window update (e.g., (Xmax−(Xmin−J))) to Sender A, and transition Sender A from JOINED 310 to ACTIVE 320 at step 414. Receiver and Sender A update the advertised window (Adv_A) and send window (win_R), respectively, at steps 414 and 415, to Xmax; for example, by adding the window update of (Xmax−(Xmin−J)) to their respective windows; i.e., Adv_A=win_R=(Xmin−J)+(Xmax−(Xmin−J))=Xmax. Steps 416-421 for Sender B are similar to steps 410-415 for Sender A.

At step 422, Sender C sends a message of size L to Receiver, and Sender C and Receiver update their windows from Xmin to (Xmin−L) at steps 423 and 424, respectively. However, at this point, Receiver cannot transition Sender C from JOINDED 310 to ACTIVE 320, because the number of active senders at Receiver has reached the threshold; i.e., # active=max_active. In one embodiment, Receiver moves Sender C to PENDING 330 at step 424 and Sender C waits there until Receiver reclaims capacity from another peer member; e.g., the least active peer member.

In the example of FIG. 4, Sender A is the least active member among the three senders at step 422, because the last message from Sender A is received before the messages from both Sender B and Sender C. Thus, at step 425, Receiver sends a reclaim request to Sender A to reclaim the unused capacity allocated to Sender A. The reclaim request informs Sender A to restore its send window to Xmin, regardless of the current size of its send window. At step 426, Receiver transitions Sender A to the RECLAIMING state 340. In response to the reclaim request, at step 427, Sending A sends a remit response to Receiver, indicating that its send window is restored to Xmin at step 428. Upon receiving the remit response, Receiver transitions Sender A to JOINED 310, and updates Adv_A to Xmin at step 429. Receiver now turns to Sender C by sending Sender C an advertisement of (Xmax−(Xmin−L)) at step 430, and transitions Sender C to ACTIVE 320. Receiver and Sender C then update the advertised window (Adv_C) and send window (win_R), respectively, at steps 431 and 432. The updated windows Adv_C and win_R have the same value, which is Adv_C=win_R=(Xmin−L)+(Xmax−(Xmin−L))=Xmax.

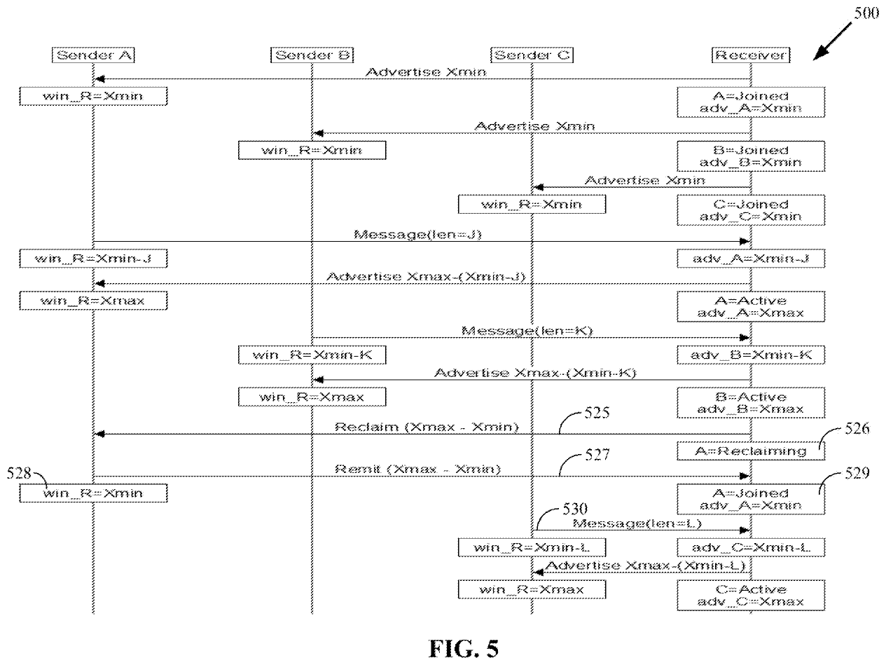

FIG. 5 illustrates a multipoint-to-point flow control diagram 500 according to another embodiment. Similar to the diagram 400 of FIG. 4, the diagram 500 illustrates message exchanges between Receiver and Sender A, Sender B and Sender C. In the scenario of FIG. 5, Receiver proactively reclaims capacity before the number of active peer members reaches the max_active threshold. In this scenario, after a peer member transitions into ACTIVE 320, the number of active peer members (# active) is compared with α×max_active where α is a factor between 0 and 1. For example, suppose α=¾ and max_active=2. After Sender B transitions into ACTIVE 320, # active=2 which is greater than α×max_active=1.5. Thus, at step 525, Receiver may proactively reclaim capacity from the least active member, Sender A, before another peer member in the JOINED 310 state sends a message to Receiver. The reclaiming steps 525-529 are similar to the corresponding reclaiming steps 425-429 in FIG. 4. However, the reclaiming steps 525-529 are performed before Sender C sends a message of size L at step 530. The proactive reclaiming allows the next sender in JOINED 310 to become active without waiting in PENDING 330. In this example, once Receiver receives the message from Sender C, Receiver can directly transition Sender C from JOINED 310 to ACTIVE 320, without having Sender C waiting in PENDING 330.

The following description further explains the flow control mechanism for a peer member in the ACTIVE state 320. Referring again to the FSM 300 in FIG. 3, when a peer member is in ACTIVE 320, the peer member consumes a portion of the Receiver's advertised window each time it sends a message to Receiver. For example, if Sender B sends a message of size M between steps 421 and 422 in FIG. 4, both the send window win_R at Sender B and the advertised window Adv_B at Receiver are updated to (Xmax−M). Receiver may restore the capacity for Sender B after receiving a number of messages from Sender B; e.g., when the remaining advertised window Adv_B reaches a low limit (i.e., when Adv_B<limit, where limit may be ⅓ of Xmax, or at least the maximum size of one message, as an example). At this point, Receiver sends an advertisement providing a window of (Xmax−Adv_B) for Sender B to restore its send window to Xmax. Receiver also updates its advertised window to Xmax. A peer member stays in the ACTIVE state 320 until Receiver reclaims its capacity, at which point the peer member transitions to the RECLAIMING state 340.

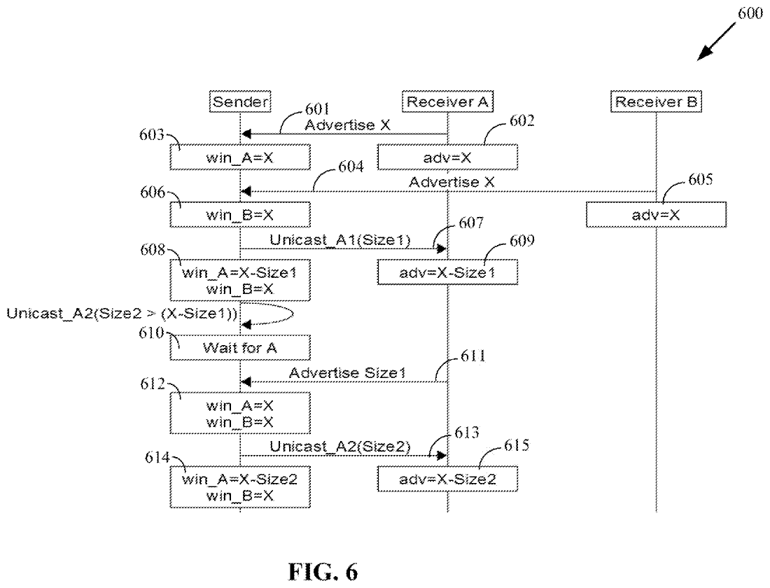

FIG. 6 illustrates a point-to-multipoint flow control diagram 600 according to one embodiment. In this example, there are one Sender and two receivers, Receiver A and Receiver B; Sender sends unicasts to Receiver A only. Initially, at steps 601-606, each receiver advertises a window X to Sender, and sets its advertised window Adv=X. Upon receiving the advertisements, Sender sets its send windows Win_A=X for Receiver A, and Win_B=X for Receiver B. At step 607, Sender sends a first unicast of Size1 to Receiver A, and at step 608 updates its send window Win_A to (X−Size1) while Win_B stays at X. Receiver A likewise updates its advertised window Adv to (X−Size1) at step 609. Suppose that Sender wants to send a second unicast of Size2 to Receiver A, where X>Size2>(X−Size1), which means that the available send window is less than the size of the second unicast. Sender waits at step 610 until Receiver A sends another advertisement to increase the sending capacity of Sender. In one embodiment, Receiver A may send another advertisement when it detects that the advertised window for Sender falls below a threshold. In one embodiment, Receiver A may increase Win_A by Size1 at step 611 to restore the send window Win_A to X at step 612; alternatively, the restored send window may be greater than the initial capacity X. After receiving the increased capacity, Sender sends a second unicast to Receiver A of Size2 at step 613. Sender and Receiver A then update their respective windows to (X−Size2) at steps 614 and 615.

As illustrated in FIG. 6, unicast falls back to regular point-to-point flow control. The receiver does not send an advertisement for each received message, as long as the advertised window for the sender has sufficient available space; e.g., the space of at least one maximum size message or another predetermined size. In one embodiment, the flow control of anycast is similar to that of unicast.

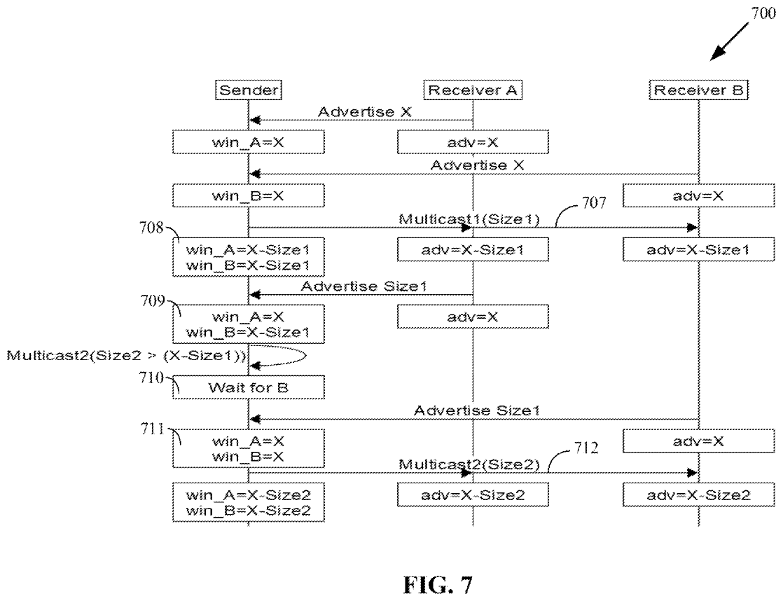

FIG. 7 illustrates a point-to-multipoint flow control diagram 700 according to another embodiment. In this example, Sender sends multicasts to both Receiver A and Receiver B. For multicast and broadcast, Sender waits until all destinations have advertised sufficient windows before Sender is allowed to send. In this example, Sender sends a first multicast of Size1 to both Receiver A and Receiver B at step 707. Sender's send windows Win_A and Win_B for both receivers are reduced from X to (X−Size1) at step 708. At step 709, Receiver A sends an advertisement to restore Win_A to X; however, Win_B stays at (X−Size1). Before Sender can send a second multicast of Size2, Sender waits at step 710 for an advertisement from Receiver B to restore its send window Win_B to X. In this example, after both Win_A and Win_B are increased to X at step 711, Sender sends the second multicast to both receivers. In one embodiment, the flow control of broadcast is similar to that of multicast.

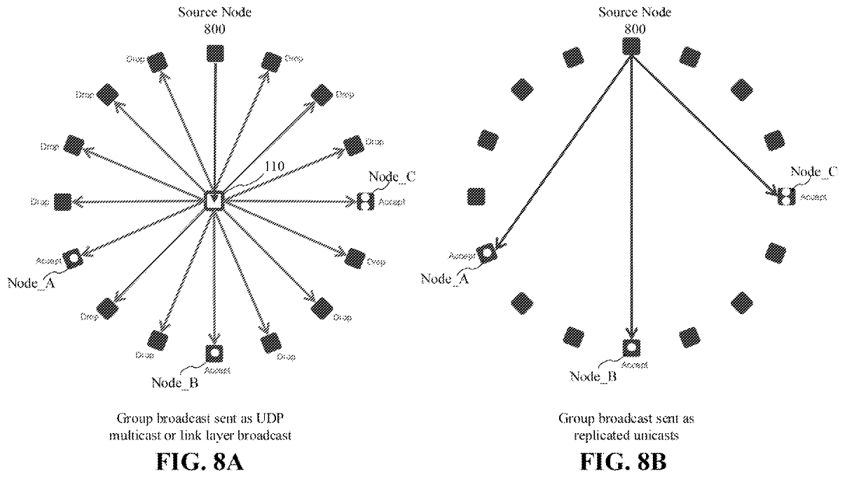

The following description is directed to sequence control mechanisms for mixed sequences of broadcast and unicast messages. FIGS. 8A and 8B illustrate two alternative transfer methods for sending a group broadcast message according to some embodiments. The term “group broadcast” refers to broadcasting of a message from a member socket to all peer members in a group, irrespective of their member IDs. Each square in FIGS. 8A and 8B represents a node, and the collection of interconnected nodes is a cluster. In one embodiment, the protocol entity 110 (FIG. 1) independently chooses one of the two transfer methods based on the relation between the number of destination nodes in the group and the cluster size (e.g., the ratio of the number of destination nodes to the cluster size), where the destination nodes are those nodes hosting peer members, and a cluster is a set of interconnected nodes.

Suppose that a member socket located on a source node 800 is about to initiate a group broadcast to peer members located on Node_A, Node_B and Node_C (referred to as the destination nodes). In the example of FIGS. 8A and 8B, there are two peer members collocated on Node_C, and one peer member on each of Node_A and Node_B. FIG. 8A illustrates a first transfer method with which the group broadcast is sent on dedicated broadcast links using broadcast; more specifically, using UDP multicast or link layer (L2) broadcast. In FIG. 8A, the sender socket on the source node 800 sends a group broadcast to all of the nodes on which the peer members are located. Only the destination nodes, Node_A, Node_B and Node_C, accept the group broadcast message and the other nodes in the cluster drop the message. In one embodiment, Node_C replicates the message for the two peer members located thereon.

FIG. 8B illustrates a second transfer method with which the group broadcast is sent as replicated unicasts. In FIG. 8B, the group broadcast message from the sender socket on the source node 800 is replicated for each of the destination nodes, and each replicated message is sent as a unicast on discrete links to only the destination nodes, Node_A, Node_B and Node_C. In one embodiment, Node_C replicates the message for the two peer members located thereon. This scenario may take place when multicast or broadcast media support is missing, or when the number of destination nodes are much smaller than the total number of nodes in the cluster; e.g., when the ratio of the number of destination nodes to the cluster size is less than a threshold.

The sender socket on the source node 800 may send a sequence of group broadcasts, or a mixed sequence of unicasts and group broadcasts, to some of its peer members. The number of destination nodes in different group broadcasts may change due to an addition of a new member on a new node or a removal of the last member on an existing node in the group. The protocol entity 110 (FIG. 1) determines, for each group broadcast and based on the number of destination nodes and cluster size, whether to send the group broadcast as broadcast (such as L2 broadcast/UDP multicast as in the example of FIG. 8A) or replicated unicasts (as in the example of FIG. 8B). In TIPC, the link layer guarantees that L2 broadcast messages are not lost or arrive out of order, but the broadcast messages may bypass previously sent unicasts from the same sender socket if there is no mutual sequence control. In one embodiment, when a sender socket needs to send a message to multiple peer members immediately after it sends out a unicast, the sender socket may send the message as replicated unicasts. If the protocol entity 110 determines that the message is to be sent by broadcast due to its large number of destination nodes, the sender socket can override the determination of the protocol entity 110 and have the message sent as replicated unicasts.

More specifically, a sender socket may convert a broadcast message which is immediately preceded by a unicast message (where the unicast message was sent during the last N seconds, N being a predetermined number) into replicated unicast messages. This conversion forces the broadcast message to follow the same data and code path as the preceding unicast message, and ensures that the unicast and the broadcast messages are received in the right order at a common destination node. Thus, the sender socket can switch the sent message types on the fly without compromising the sequential delivery of messages of different types.

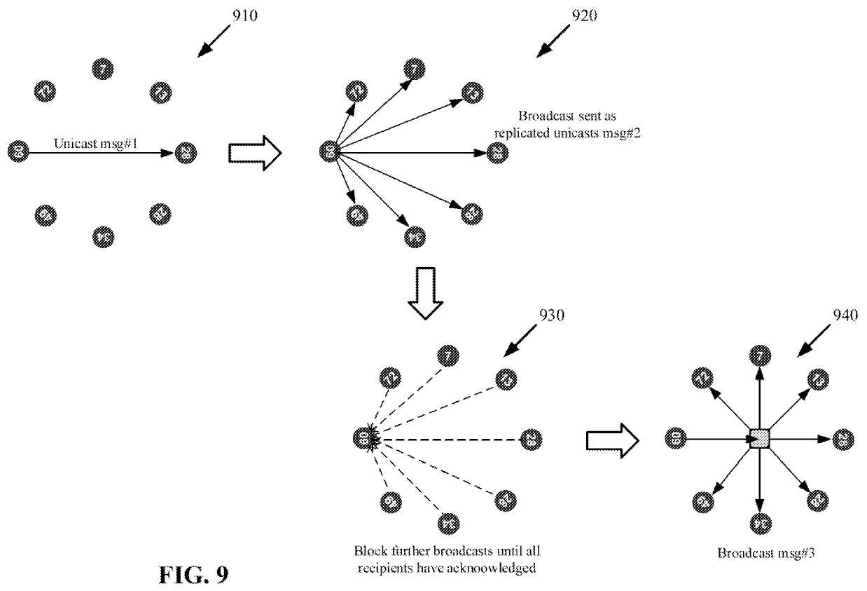

FIG. 9 illustrates a sequence control mechanism for a sender socket sending a broadcast message immediately after a unicast message according to one embodiment. In this example, a sender socket (e.g., socket 60) sends a sequence of messages (msg #1, msg #2 and msg #3) to its peer members. From top left to bottom right, the sender socket begins at 910 with sending a unicast message (msg #1) to a peer member socket 28. At 920, the sender socket sends a broadcast message (msg #2) to its peer members, including the previous recipient socket 28. Because this broadcast message is sent immediately after a unicast message, msg #2 is sent as replicated unicast messages. The sender socket waits at 930 until all destinations of the replicated unicast messages acknowledge the receipt of msg #2. Further broadcast message (but not unicast) attempts are rejected until all destinations have acknowledged. At 940, when all destinations have acknowledged, the sender socket may send another broadcast message, msg #3, to all peer members. For msg #3 and subsequent broadcast messages, the protocol entity 110 (FIG. 1) may determine whether to send msg #3 by L2 broadcast/UDP multicast or by replicated unicasts, based on the number of destination nodes versus the cluster size.

In a second scenario, a unicast message may immediately follow a broadcast message. As mentioned before, the link layer delivery guarantees that messages are not lost but may arrive out of order due to the change between link layer broadcast and replicated unicasts. In one embodiment, sequence numbers are used to ensure the sequential delivery of a mixed sequence of broadcast and unicast messages where a unicast message is immediately preceded by a broadcast message.

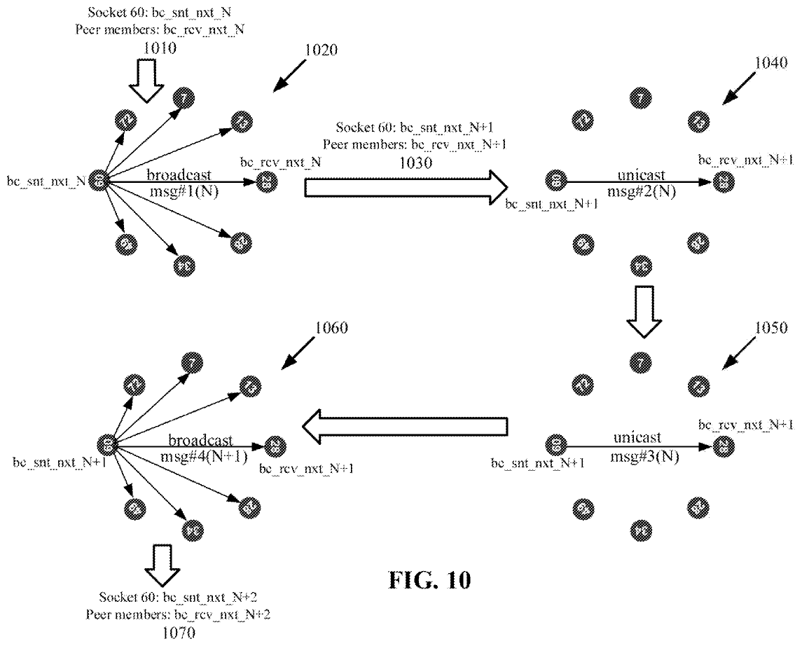

FIG. 10 illustrates another sequence control mechanism for a sender socket sending a unicast message immediately after a broadcast message according to one embodiment. In this example, each sender socket in a group keeps a sequence number field containing a next-sent broadcast message sequence number, and each receiver socket keeps a sequence number field per peer member containing a next-received broadcast message sequence number from that peer. Each member keeps a per peer member re-sequencing queue for such cases. At 1010, the next-sent broadcast message sequence number at the sender socket (socket 60) is N (i.e., bc_snt_nxt_N), and the next-received broadcast message sequence number from socket 60 for each peer member is also N (i.e., bc_rcv_nxt_N). At 1020, the sender socket broadcasts msg #1 to it peer members, where msg #1 carries the sequence number N. At 1030, the sender socket and its peer members increment their next-sent/received sequence numbers to bc_snt_nxt_N+1 and bc_rcv_nxt_N+1, respectively. At 1040, the sender socket sends msg #2 to one of the peer members by unicast, where msg #2 carries a sequence number that uniquely identifies the previously-sent broadcast message msg #1. In this example, the sequence number of msg #2 is N, which is the same as the sequence number of msg #1. In an alternative embodiment, the sequence number of msg #2 may be a predetermined increment (e.g., plus one) of the sequence number of msg #1. The next-sent/received sequence numbers at the sender socket and the peer members stay at N+1. At 1050, the sender socket sends msg #3 to one of the peer members by unicast, where msg #3 carries the same sequence number N as in the previous unicast. The next-sent/received sequence numbers at the sender socket and the peer member stay at N+1. At 1060, the sender socket broadcasts msg #4 to it peer members, where msg #4 carries the sequence number N+1. At 1070, the sender socket and its peer members increment their next-sent/received sequence numbers to bc_snt_nxt_N+2 and bc_rcv_nxt_N+2, respectively.

The sequence numbers carried by the unicast messages ensures that the receiver is informed of the proper sequencing of a unicast message in relation to a prior broadcast message. For example, if the unicast msg #2 bypasses the broadcast msg #1 on the way to socket 28, socket 28 can sort out the proper sequencing by referring to the sequence numbers.

Embodiments of the flow control and the sequence control described herein provide various advantages over conventional network protocols. For example, the sockets can be implemented with efficient usage of memory. According to standard TIPC or TCP protocols, a receiver socket needs to reserve a receive queue size of (N×Xmax) for N peer members. By contrast, according to the flow control described herein, a receiver socket only needs to reserve a receive queue size of ((N−M)×Xmin)+(M×Xmax) for N peer members with M active peer members, where M<<N and Xmin<<Xmax. Active peer members are those sockets in the Active state 320 (FIG. 3); the other peer members in the group are referred to as non-active sockets. Moreover, the communication among the sockets is bandwidth efficient. Broadcast may leverage L2 broadcast or UDP multicast whenever such a support is available. The broadcast mechanism described herein can scale to hundreds or more members without choking the network.

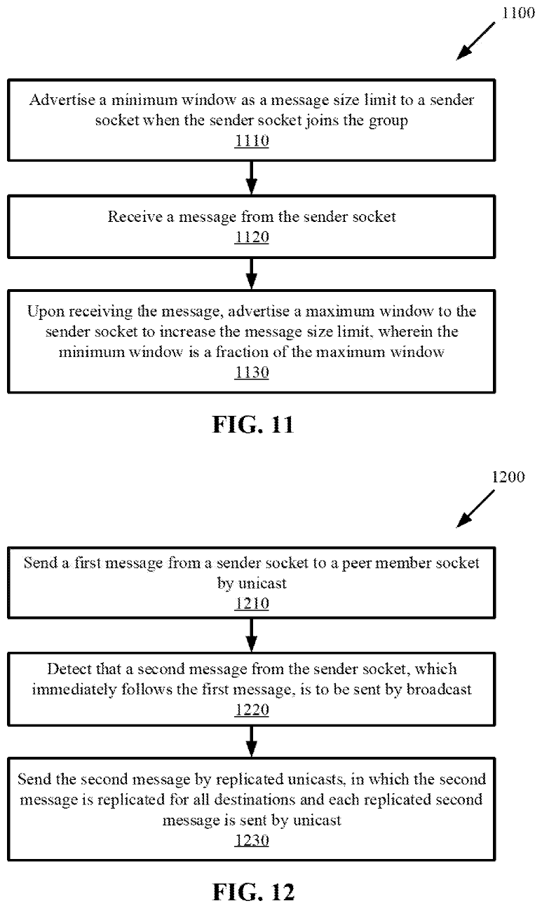

FIG. 11 is a flow diagram illustrating a flow control method 1100 according to one embodiment. The method 1100 may be performed by a receiver socket in a group of sockets in a network for providing flow control for the group. At step 1110, the method 1100 begins with the receiver socket advertising a minimum window as a message size limit to a sender socket when the sender socket joins the group. At step 1120, the receiver socket receives a message from the sender socket. Upon receiving the message, at step 1130, the receiver socket advertises a maximum window to the sender socket to increase the message size limit. The minimum window is a fraction of the maximum window.

FIG. 12 is a flow diagram illustrating a sequence control method 1200 according to one embodiment. The method 1200 may be performed by a sender socket in a group of sockets in a network for providing sequence control for the group. In one embodiment, the method 1200 begins at step 1210 with the sender socket sending a first message to a peer member socket by unicast. At step 1220, the sender socket detects that a second message, which immediately follows the first message, is to be sent by broadcast. At step 1230, the sender socket sends the second message by replicated unicasts, in which the second message is replicated for all destinations and each replicated second message is sent by unicast. In one embodiment, the sender socket waits for acknowledgements of the second message from all of its peer members. until the sender socket can sends a next broadcast message. The next broadcast message may be sent by broadcast or by replicated unicasts, depending on the number of destination nodes versus the cluster size.

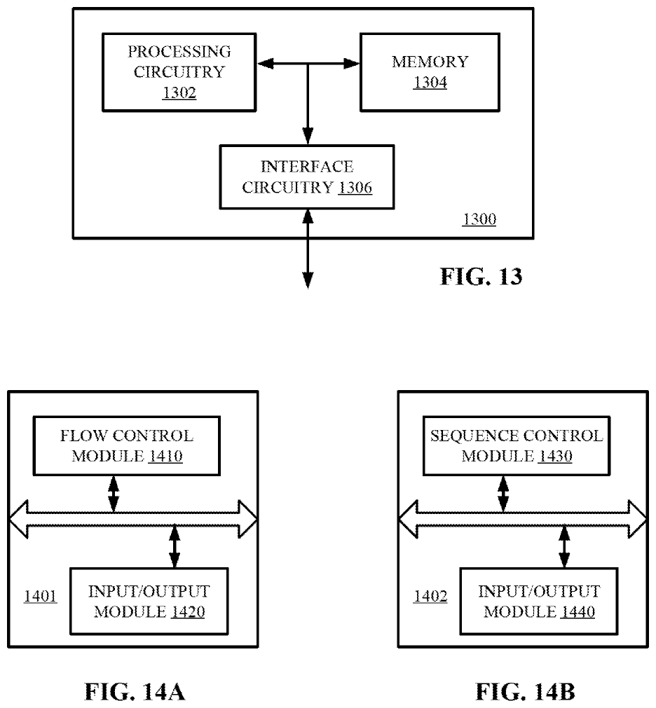

FIG. 13 is a block diagram illustrating a network node 1300 according to an embodiment. In one embodiment, the network node 1300 may be a server in an operator network or in a data center. The network node 1300 includes circuitry which further includes processing circuitry 1302, a memory 1304 or instruction repository and interface circuitry 1306. The interface circuitry 1306 can include at least one input port and at least one output port. The memory 1304 contains instructions executable by the processing circuitry 1302 whereby the network node 1300 is operable to perform the various embodiments described herein.

FIG. 14A is a block diagram of an example network node 1401 for performing flow control according to one embodiment. In one embodiment, the network node 1401 may be a server in an operator network or in a data center. The network node 1401 includes a flow control module 1410 adapted or operative to advertise a minimum window as a message size limit to a sender socket when the sender socket joins the group. The network node 1401 also includes an input/output module 1420 adapted or operative to receive a message from the sender socket. The flow control module 1410 is further adapted or operative to advertise, upon receiving the message, a maximum window to the sender socket to increase the message size limit. The minimum window is a fraction of the maximum window. The network node 1401 can be configured to perform the various embodiments as have been described herein.

FIG. 14B is a block diagram of an example network node 1402 for performing sequence control according to one embodiment. In one embodiment, the network node 1402 may be a server in an operator network or in a data center. The network node 1402 includes an input/output module 1440 adapted or operative to send a first message to a peer member socket by unicast. The network node 1402 also includes a sequence control module 1430 adapted or operative to detect that a second message from the sender socket, which immediately follows the first message, is to be sent by broadcast. The input/output module 1440 is further adapted or operative to send the second message by replicated unicasts, in which the second message is replicated for all destinations and each replicated second message is sent by unicast. The network node 1402 can be configured to perform the various embodiments as have been described herein.

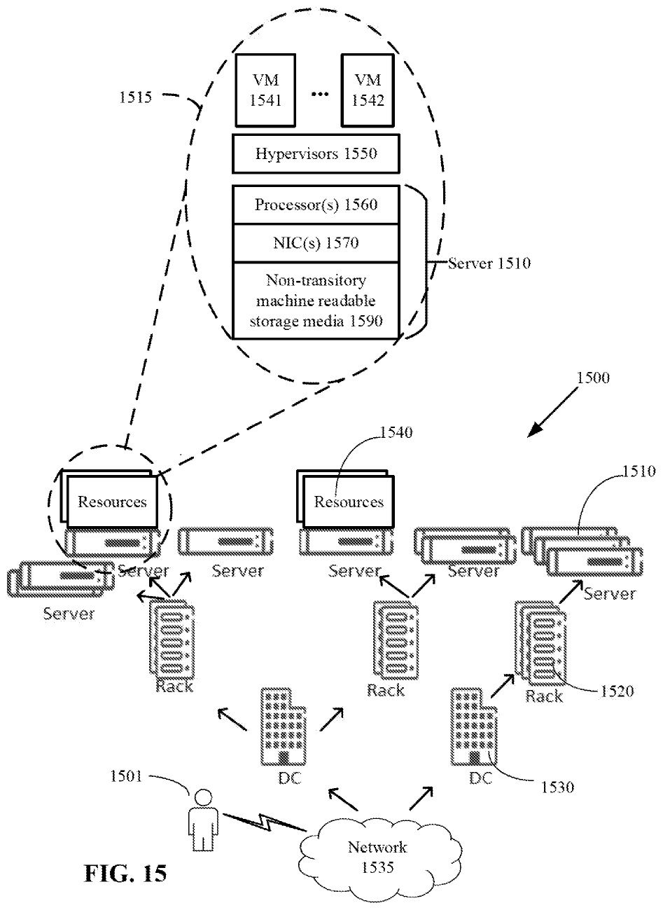

FIG. 15 is an architectural overview of a cloud computing environment 1500 that comprises a hierarchy of a cloud computing entities. The cloud computing environment 1500 can include a number of different data centers (DCs) 1530 at different geographic sites connected over a network 1535. Each data center 1530 site comprises a number of racks 1520, each rack 1520 comprises a number of servers 1510. It is understood that in alternative embodiments a cloud computing environment may include any number of data centers, racks and servers. A set of the servers 1510 may be selected to host resources 1540. In one embodiment, the servers 1510 provide an execution environment for hosting entities and their hosted entities, where the hosting entities may be service providers and the hosted entities may be the services provided by the service providers. Examples of hosting entities include virtual machines (which may host containers) and containers (which may host contained components), among others. A container is a software component that can contain other components within itself. Multiple containers can share the same operating system (OS) instance, and each container provides an isolated execution environment for its contained component. As opposed to VMs, containers and their contained components share the same host OS instance and therefore create less overhead. Each of the servers 1510, the VMs, and the containers within the VMs may host any number of sockets, for which the aforementioned flow control and sequence control may be practiced.

Further details of the server 1510 and its resources 1540 are shown within a dotted circle 1515 of FIG. 15, according to one embodiment. The cloud computing environment 1500 comprises a general-purpose network device (e.g. server 1510), which includes hardware comprising a set of one or more processor(s) 1560, which can be commercial off-the-shelf (COTS) processors, dedicated Application Specific Integrated Circuits (ASICs), or any other type of processing circuit including digital or analog hardware components or special purpose processors, and network interface controller(s) 1570 (NICs), also known as network interface cards, as well as non-transitory machine readable storage media 1590 having stored therein software and/or instructions executable by the processor(s) 1560.

During operation, the processor(s) 1560 execute the software to instantiate a hypervisor 1550 and one or more VMs 1541, 1542 that are run by the hypervisor 1550. The hypervisor 1550 and VMs 1541, 1542 are virtual resources, which may run node instances in this embodiment. In one embodiment, the node instance may be implemented on one or more of the VMs 1541, 1542 that run on the hypervisor 1550 to perform the various embodiments as have been described herein. In one embodiment, the node instance may be instantiated as a network node performing the various embodiments as described herein.

In an embodiment, the node instance instantiation can be initiated by a user 1501 or by a machine in different manners. For example, the user 1501 can input a command, e.g., by clicking a button, through a user interface to initiate the instantiation of the node instance. The user 1501 can alternatively type a command on a command line or on another similar interface. The user 1501 can otherwise provide instructions through a user interface or by email, messaging or phone to a network or cloud administrator, to initiate the instantiation of the node instance.

Embodiments may be represented as a software product stored in a machine-readable medium (such as the non-transitory machine readable storage media 1590, also referred to as a computer-readable medium, a processor-readable medium, or a computer usable medium having a computer readable program code embodied therein). The non-transitory machine-readable medium 1590 may be any suitable tangible medium including a magnetic, optical, or electrical storage medium including a diskette, compact disk read only memory (CD-ROM), digital versatile disc read only memory (DVD-ROM) memory device (volatile or non-volatile) such as hard drive or solid state drive, or similar storage mechanism. The machine-readable medium may contain various sets of instructions, code sequences, configuration information, or other data, which, when executed, cause a processor to perform steps in a method according to an embodiment. Those of ordinary skill in the art will appreciate that other instructions and operations necessary to implement the described embodiments may also be stored on the machine-readable medium. Software running from the machine-readable medium may interface with circuitry to perform the described tasks.

The above-described embodiments are intended to be examples only. Alterations, modifications and variations may be effected to the particular embodiments by those of skill in the art without departing from the scope which is defined solely by the claims appended hereto.

1. A method performed by a receiver socket in a group of sockets in a network for providing flow control for the group, comprising:
advertising a minimum window as a message size limit to a sender socket when the sender socket joins the group;
receiving a message from the sender socket; and
upon receiving the message, advertising a maximum window to the sender socket to increase the message size limit, wherein the minimum window is a fraction of the maximum window.

2. The method of claim 1, wherein advertising the maximum window further comprises:
transitioning the sender socket from a joined state to an active state; and
if a total number of sockets in the active state is within a threshold from an allowable number of active sockets, reclaiming capacity from a selected socket in the active state.

3. The method of claim 2, wherein the selected active socket is a least active socket among the sockets in the active state.

4. The method of claim 1, wherein advertising the maximum window further comprises:
transitioning the sender socket from a joined state to a pending state when a total number of sockets in an active state is equal to an allowable number of active sockets.

5. The method of claim 4, further comprising:
reclaiming capacity from a least active socket among the sockets in the active state; and
transitioning the sender socket from the pending state to the active state upon receiving the reclaimed capacity from the least active socket.

6. The method of claim 5, wherein reclaiming the capacity further comprises:
reclaiming the capacity from the least active socket by reducing the message size limit of the least active socket to the minimum window.

7. The method of claim 1, wherein a combined total capacity provided by the receiver socket to peer members in the group is a sum of the maximum window multiplied by the number of active sockets in the group and the minimum window multiplied by the number of non-active sockets in the group.

8. The method of claim 7, further comprising:
updating, by the receiver socket, an advertised window after receiving the message from the sender socket, wherein the advertised window keeps track of an available capacity provided to the sender socket; and
when the advertised window is below a predetermined limit, replenishing the available capacity provided to the sender socket to the maximum window.

9. The method of claim 1, wherein the receiver socket is selected as a recipient of an anycast message from a subset of the sockets associated with a same member identifier, based on, at least in part, a load level of the receiver socket.

10. (canceled)

11. (canceled)

12. (canceled)

13. (canceled)

14. (canceled)

15. A node containing a receiver socket in a group of sockets in a network, the node adapted to perform flow control for communicating with the sockets in the group, comprising:
a circuitry adapted to cause the receiver socket in the node to:
advertise a minimum window as a message size limit to a sender socket when the sender socket joins the group;
receive a message from the sender socket; and
upon receiving the message, advertise a maximum window to the sender socket to increase the message size limit, wherein the minimum window is a fraction of the maximum window.

16. The node of claim 15, wherein the circuitry comprises a processor, a memory and an interface both coupled with the processor, the memory containing instructions that when executed cause the processor to perform operations of advertising the minimum window, receiving the message and advertising the maximum window.

17. The node of claim 15, wherein the circuitry is further adapted to cause the receiver socket in the node to:
transition the sender socket from a joined state to an active state when receiving the message; and
if a total number of sockets in the active state is within a threshold from an allowable number of active sockets, reclaim capacity from a selected socket in the active state.

18. The node of claim 17, wherein the selected active socket is a least active socket among the sockets in the active state.

19. The node of claim 15, wherein the circuitry is further adapted to cause the receiver socket in the node to:
transition the sender socket from a joined state to a pending state when a total number of sockets in an active state is equal to an allowable number of active sockets.

20. The node of claim 19, wherein the circuitry is further adapted to cause the receiver socket in the node to:
reclaim capacity from a least active socket among the sockets in the active state; and
transition the sender socket from the pending state to the active state upon receiving the reclaimed capacity from the least active socket.

21. The node of claim 20, wherein the circuitry is further adapted to cause the receiver socket in the node to:
reclaim the capacity from the least active socket by reducing the message size limit of the least active socket to the minimum window.

22. The node of claim 15, wherein a combined total capacity provided by the receiver socket to peer members in the group is a sum of the maximum window multiplied by the number of active sockets in the group and the minimum window multiplied by the number of non-active sockets in the group.

23. The node of claim 22, wherein the circuitry is further adapted to cause the receiver socket in the node to:
update an advertised window after receiving the message from the sender socket, wherein the advertised window keeps track of an available capacity provided to the sender socket; and
when the advertised window is below a predetermined limit, replenish the available capacity provided to the sender socket to the maximum window.

24. The node of claim 15, wherein the receiver socket is selected as a recipient of an anycast message from a subset of the sockets associated with a same member identifier, based on, at least in part, a load level of the receiver socket.

25. (canceled)

26. (canceled)

27. (canceled)

28. (canceled)

29. (canceled)

30. (canceled)

31. (canceled)

32. (canceled)

33. (canceled)

34. (canceled)
